(19) United States
(12) Patent Application Publication
(10) Pub. No.: US 2012/0223154 A1
(43) Pub. Date: Sep. 6, 2012

(54) ATOMIZER

(75) Inventors: Yi-Hsin Huang, New Taipei City (TW); Chao-Wang Chen, New Taipei City (TW)

(73) Assignee: TAIDOC TECHNOLOGY CORPORATION

(21) Appl. No.: 13/411,828

(22) Filed: Mar. 5, 2012

(30) Foreign Application Priority Data
Mar. 3, 2011 (TW) 100107269

(51) Int. Cl. B05B 1/00

(52) U.S. Cl. 239/102.1

(57) ABSTRACT

The present invention related to an atomizer is provided. The atomizer includes a liquid storage cup, a vibration device, and a lid. The liquid storage cup is used to storage liquid. The vibration device is disposed through the liquid storage cup. The vibration device can vibrate in high frequency. The distance between a top of the vibration device and a bottom of the liquid storage cup is less than 3 mm. The lid includes a mesh. When the lid combines with the liquid storage cup, the mesh touches the top of the vibration device.

### BACKGROUND OF THE INVENTION

1. Field of the Invention

The present invention relates to an atomizer, and especially is relevant to a technology of a liquid transport of the atomizer.

2. Description of the Related Art

For recent years, an atomizer is more universal and widespread of its application. For example, the atomizer can atomize liquid drugs to patients for inspiration and atomize and spread essential oils in the environment rapidly. Further, the atomizer can be used to atomize water in order to increase the air humidity or decrease the environmental temperature. Directed to some part of plants, the atomizer also can be the watering device. The atomizer is classified in many different kinds of type depending on atomized technologies. The following is further illustration about the atomizer utilizing capillarity for liquid transport through atomizing liquid by high frequency vibration and the mesh.

FIG. 1 is a partial schematic perspective view of an atomizer in the prior art. Please refer to FIG. 1. A liquid storage cup 101 is used to storage liquid. A vibration device 102 can vibrate in high frequency. A lid 103 is used to cover the liquid storage cup 101. In the prior art, a distance between a top of the vibration device 102 and the liquid storage cup 101 is more than 10 mm so that there need a liquid transport structure 105 to transport the liquid.

Following the description above, the liquid transport structure 105 is half-arc shaped. The space between the liquid transport structure 105 and the vibration device 102 is quit small. According to the capillarity, the liquid in a bottom of the liquid storage cup 101 is transported along with the space between the liquid transport structure 105 and the vibration device 102 and is up to the top of the vibration device 102. When the vibration device 102 touches a mesh 104 and vibrates at high frequencies, the liquid on the top of the vibration device 102 will pass through the mesh then atomized.

To be noticed, the way of liquid transported by the capillarity as description above sometimes may not correctly transport the liquid to the top of the vibration device 102, and therefore, the liquid can not be atomized by the atomizer. Users may easy to mistake this situation as a malfunction of the atomizer and carry out it to repair. For example, under an over drying condition, it may not be successfully transporting the liquid by the capillarity to the top of the vibration device 102. For another example, after the liquid evaporated from the liquid transport structure 105 will leave a trace on a surface and the trace may be formed a barrier so that the liquid can not be transported successfully to the top of the vibration device 102 by the capillarity. Thus, a need exists for improved the device such as atomizer.

### SUMMARY OF THE INVENTION

According to one aspect of the present invention is to provide an atomizer for decrease the rate of malfunction.

In one aspect of the present invention, the present invention provides an atomizer, including a liquid storage cup, a vibration device, and a lid. The liquid storage cup is used to storage liquid. The vibration device is disposed through the liquid storage cup. The vibration device can vibrate in high frequency. A distance between a top of the vibration device and a bottom of the liquid storage cup is less than 3 mm. The lid includes a mesh. When the lid combines with the liquid storage cup, the mesh touches the top of the vibration device.

In an embodiment in accordance with the present invention, the atomizer further includes a waterproofing body. The waterproofing body is disposed between the liquid storage cup and the lid. In another embodiment, the waterproofing body is disposed between the liquid storage cup and the vibration device.

In an embodiment in accordance with the present invention, the liquid storage cup is depressed from a center of the vibration device. In another embodiment, the mesh has many tiny apertures.

According to the aspect of the present invention as description above, the atomizer shows that the distance between a top of the vibration device and a bottom of the liquid storage cup is less than 3 mm, and can transport the liquid to the top of the vibration device by an adhesion of the liquid with the vibration device. It provides the atomizer not only having simple structure but also decrease the rate of the malfunction.

### BRIEF DESCRIPTION OF THE DRAWINGS

The following drawings form part of the present specification and are included to further demonstrate certain aspects of the present invention. The invention may be better understood by reference to one or more of these drawings in combination with the detailed description of specific embodiments presented herein.

FIG. 1 is a partial schematic perspective view of an atomizer in the prior art;

FIG. 2 is a schematic perspective view of a first embodiment of an atomizer in accordance with the present invention;

FIG. 3 is a schematic perspective view of a second embodiment of an atomizer in accordance with the present invention;

FIG. 4 is a partial exploded perspective view of the atomizer in FIG. 3;

FIG. 5 is a schematic perspective view of the partial atomizer in FIG. 4; and

FIG. 6 is a cross-sectional view of the partial atomizer in FIG. 5

### DESCRIPTION OF THE PREFERRED EMBODIMENTS

For the purposes of promoting an understanding of the principles of the invention, reference will now be made to the embodiment illustrated in the drawings, and specific language will be used to describe that embodiment. It will nevertheless be understood that no limitation of the scope of the invention is intended. Alterations and modifications in the illustrated device, and further applications of the principles of the invention as illustrated therein, as would normally occur to one skilled in the art to which the invention relates are contemplated, are desired to be protected. Such alternative embodiments require certain adaptations to the embodiments discussed herein that would be obvious to those skilled in the art.

The following description and accompanying drawings are some examples in accordance with the present invention. The same symbol herein in the drawings indicates the same or similar structure.

With reference to FIG. 2, it is a schematic perspective view of a first embodiment of an atomizer in accordance with the present invention. The atomizer 10 comprises a liquid storage cup 20, a vibration device 30 and a lid 40. The liquid storage cup 20 is used to storage liquid, such as water, liquid drugs, essential oils and so on. The vibration device 30 is disposed through the liquid storage cup 20 and vibrates in high frequency. For example, the vibration device 30 could be an ultrasonic oscillator. The lid 40 comprises a mesh 50 having many tiny apertures. The mesh 50 could constitute of the metal, but the present invention should not be limited in it. When the lid 40 combines with the liquid storage cup 20, the mesh 50 will touch a top of the vibration device 30. When the vibration device 30 touches the mesh 50 and vibrates in high frequency, the liquid on the top of the vibration device 30 will pass through the mesh 50 and then atomized.

To be noticed, in the present embodiment, a distance X2 between the top of the vibration device 30 and the bottom of the liquid storage cup 20 preferably is 3 mm, but the present invention shall not be limited in it. In other embodiment, the distance X2 could be less than 3 mm, for example, as 2.5 mm, 2 mm, 1.5 mm, 1 mm, 0.5 mm and so on.

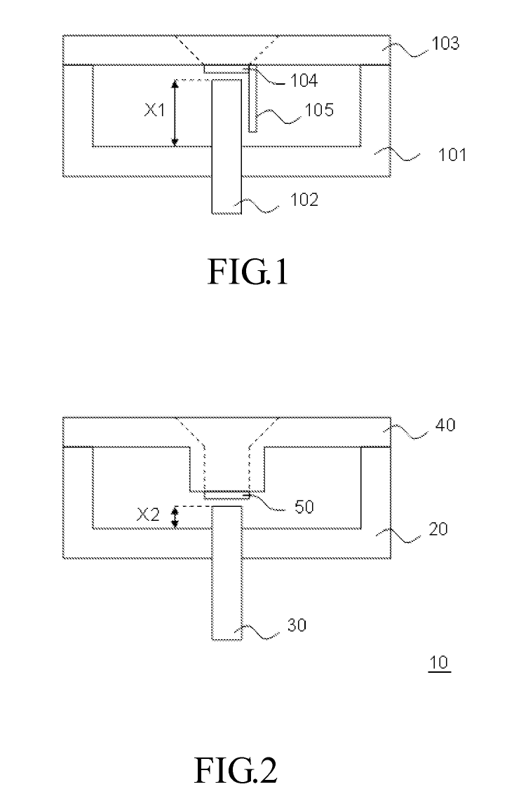

Following the description above, because of the distance X2 in the embodiment is quit small, the liquid stored in the liquid storage cup 20 can transport to the top of the vibration device 30 based on the adhesion of the liquid along with lateral wall of the vibration device 30. When the liquid on the top of the vibration device 30 passed through the mesh 50 and then atomized, the liquid in the bottom of liquid storage cup 101 subsequently continually transports to the top of the vibration device 30. Compare the present embodiment with the prior art as FIG. 1 shown, the embodiment in accordance with the present invention not only omitting the liquid transport structure 105, but also still having the efficacy of liquid transported. Not only that, the embodiment in accordance with the present invention can improve the problem of the atomizer as FIG. 1 shown that transports the liquid by the liquid transport structure 105 sometimes may not transport the liquid correctly.

To be noticed, although possible types of the atomizer in accordance with the present invention has been described in the embodiment above, those skilled in the art shall recognized that the atomizer can be designed differently. Therefore, the spirit of the present invention shall not be limited to these possible types of atomizer in accordance with the present invention. In other words, the distance between the top of the vibration device and the bottom of the liquid storage cup can be less than 3 mm is the key spirit and scope of the present invention. The followings are some other embodiments in accordance with the present invention for those skilled in the art to know more about the spirit of the present invention.

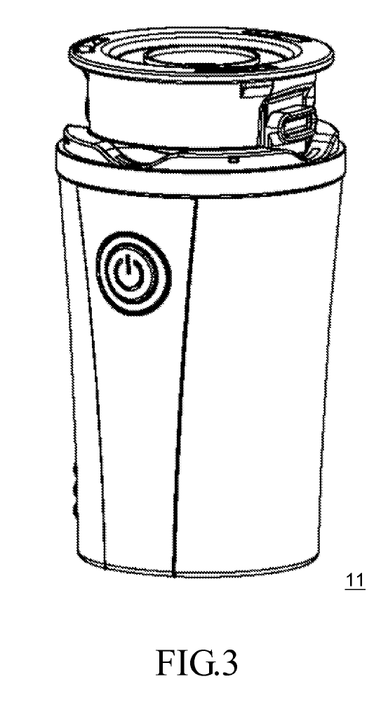

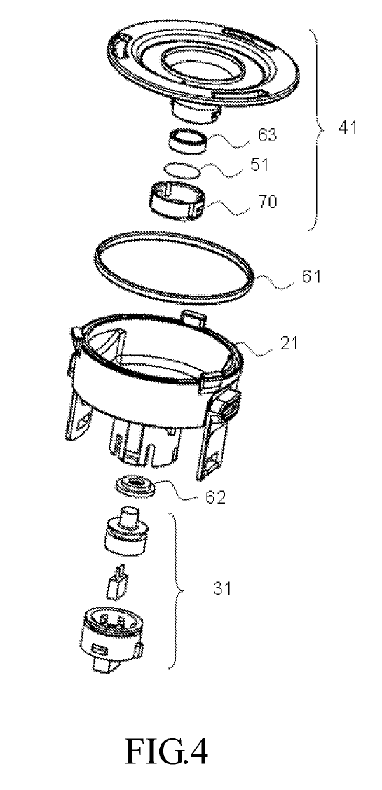

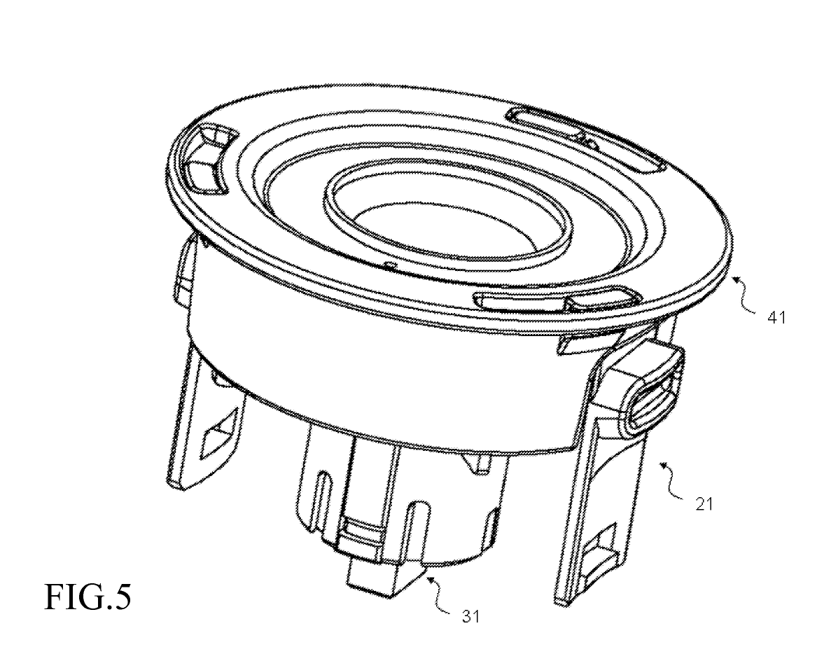

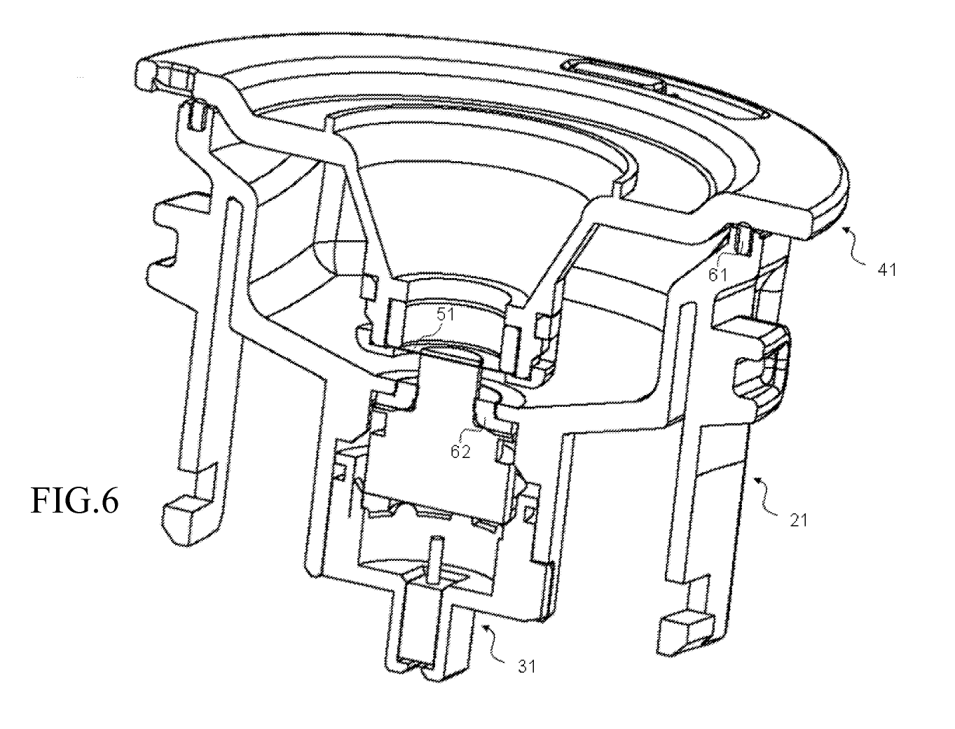

FIG. 3 is a schematic perspective view of a second embodiment of an atomizer in accordance with the present invention. FIG. 4 is a partial exploded perspective view of the atomizer in FIG. 3. FIG. 5 is a schematic perspective view of the partial atomizer in FIG. 4. FIG. 6 is a cross-sectional view of the partial atomizer in FIG. 5. Further refer to FIGS. 3 to 6 in combination. In the present embodiment, an atomizer 11 comprises a liquid storage cup 21, a vibration device 31, a lid 41, and waterproofing bodies 61 and 62. The liquid storage cup 21 is depressed from a center of the vibration device 31. In other words, liquid in the liquid storage cup 21 converges toward the vibration device 31. The waterproofing body 61 is disposed between the liquid storage cup 21 and the lid 41 for proofing water. The waterproofing body 62 is disposed between the liquid storage cup 21 and the vibration device 31 for proofing water. The lid 41 comprises a mesh 51, a waterproofing body 63 and a securing device 70. The waterproofing body 63 can prevent leaky of the liquid. The securing device 70 is used to fix the mesh 51 and the waterproofing body 63.

To be noticed, the aperture of the mesh 51 is quit small so that the liquid is not easy to pass through the mesh 51 in nature. Therefore, when the liquid storage cup 21, the vibration device 31, the lid 41, the waterproofing bodies 61 and 62 are assembled, the liquid storage cup 21 forms a partial-sealed space. When in nature, even if the liquid in the liquid storage cup 21 is higher than the mesh 51, the liquid is not leaky from the liquid storage cup 21. When the vibration device 31 touches the mesh 51 and vibrates in high frequency, the liquid on the top of the vibration device 31 will pass through the mesh 51 and then atomized.

The atomizer in accordance with the present invention has following advantages.

1. The liquid storage cup is depressed from the center of the vibration device and the liquid in the liquid storage cup converge toward the vibration device.

2. The aperture of the mesh is quit small, and the liquid storage cup coordinated with the waterproofing body can form a partial-sealed space. When in nature, even if the liquid in the liquid storage cup is higher than the mesh, the liquid is not leaky from the liquid storage cup.

More exemplary embodiments and advantages of the present invention may be ascertained by reviewing the present disclosure and the accompanying drawing. It is intended that the description and embodiments with reference to the accompanying drawing to be considered as exemplary only.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

Other embodiments of the invention will appear to those skilled in the art from consideration of the specification and practice of the invention disclosed herein. It is intended that the specification and examples to be considered as exemplary only, with a true scope and spirit of the invention being indicated by the following claims.

What is claimed is:

1. An atomizer comprising:
a liquid storage cup used to storage liquid;
a vibration device disposed through said liquid storage cup and used to vibrate in high frequency, wherein a distance between a top of said vibration device and a bottom of said liquid storage cup is less than 3 mm; and
a lid comprising a mesh, and when said lid combined with said liquid storage cup, said mesh touched the top of said vibration device.

2. The atomizer as claimed in claim 1, further comprising:
a waterproofing body disposed between said liquid storage cup and said lid.

3. The atomizer as claimed in claim 1, further comprising:
a waterproofing body disposed between said liquid storage cup and said vibration device.

4. The atomizer as claimed in claim 1, wherein said liquid storage cup is depressed from a center of the vibration device.

5. The atomizer as claimed in claim 1, wherein said mesh has many tiny apertures.
